(19) United States
(12) Patent Application Publication
(10) Pub. No.: US 2022/0388186 A1
(43) Pub. Date: Dec. 8, 2022

(54) SAFETY KNIFE

(71) Applicant: SoloSecure, Inc., Pleasanton, CA (US)

(72) Inventors: Iasha King, Pleasanton, CA (US); Nathan K. Ramanathan, Pleasanton, CA (US)

(21) Appl. No.: 17/832,176

(22) Filed: Jun. 3, 2022

Related U.S. Application Data
(60) Provisional application No. 63/196,543, filed on Jun. 3, 2021.

(51) Int. Cl. B26B 1/08; B26B 7/00

(52) U.S. Cl. CPC B26B 1/08; B26B 7/00

(57) ABSTRACT

A safety knife is provided that includes a handle, defining a cavity with an opening on a first end, and including a print scanner and an activation trigger; a slider assembly including a half-nut and a blade; a motor configured to rotate a lead screw engaged with the half-nut when the print scanner matches a received biometric marker to a stored biometric marker and when the activation trigger is engaged to push the slider assembly in a first direction to expose the blade; and a return spring connected to the slider assembly and to a second end of the handle, wherein pushing the slider assembly in the first direction places the return spring under tension and the return spring pulls the slider assembly in a second direction to retract the blade into the cavity when the half-nut disengages the lead screw.

### CROSS-REFERENCES TO RELATED APPLICATIONS

The present disclosure claims priority to U.S. Provisional Patent Application No. 63/196,543 filed on 2021 Jun. 3 entitled “SAFETY KNIFE”, which is incorporated herein by reference in its entirety.

### FIELD

Described herein are safety knives and the methods of using the safety knives.

### SUMMARY

Described herein generally are safety knives and their methods of use.

In some embodiments, a biometric, fingerprint authenticated, Bluetooth connected, out-the-front knife (“Knife”) is described herein. The Knife can include a slider assembly with a blade attached to the slider assembly. The Knife can include, but is not limited to, two states, an extended position and a retracted position. In other embodiments, at the extended position, the blade protrudes through the front of the handle, and at the retracted position, the blade is in the handle. In some embodiments, the handle includes a Li-ion polymer battery power source, a micro-motor with gear assembly attached to a leadscrew, in which the leadscrew runs along the length of the handle, a fingerprint or other biometric print sensor, a Bluetooth connectivity circuit, and a RFID antenna. In some embodiments, the slider assembly slides on grooves or rails inside the handle frame and is attached to a pull or return spring that is in turn attached to the back end of the handle body. The slider assembly includes a rocker arm assembly that has a half-nut. In some embodiments, the half-nut engages and disengages with the leadscrew by toggling the rocker arm assembly in an up/disengaged or down/engaged position.

In some embodiments, a Knife user can pair the Knife by registering their thumb fingerprint or other biometric marker using the print scanner to set-up the Knife. In other embodiments, without the print pairing, the Knife is not operable. In some embodiments, the Knife further includes a mobile connected device with Bluetooth capability to authenticate the Knife user and also acts as an SOS device. When the Knife is paired with a Knife user and connected to their mobile device, the Knife user can activate the Knife by placing their thumb or other portion of their hand on the print scanner and pushing an authentication button down. This authenticates the user and powers the Knife, if the fingerprint matches the Knife User. By pressing an activation trigger at the bottom on the handle (e.g., using their index finger while the thumb is pressing the authentication button), the Knife user can power the motor, which in turn rotates the leadscrew. The activation trigger and/or authentication button can be depressed by using any digit/finger of the hand. The rocker arm with the half-nut is engaged with the leadscrew. When the leadscrew rotates, the half-nut slides forward, thereby moving the slider assembly forward. This movement results in the blade protruding out of the handle through the front. When the slider assembly reaches the end of travel, the rocker arm is pushed upwards by a push-up ramp toggling up the rocker arm and thereby disengaging the half-nut from the lead screw, which stops the forward motion of the slider assembly. The slider assembly is now under tension by the pull spring, but held in place by a lock pin included on an underside of the authentication button. The lock pin, with the pressure from the Knife user's grip on the Knife, holds the slider assembly from sliding back, which keeps the blade in an extended position, (e.g. protruded out of the handle). In some embodiments, this position of the slider assembly triggers the Bluetooth sensor to send signal to the mobile connected device, which prompts the mobile device to send out SOS message(s) to a contact that is preregistered.

When the Knife users releases their grip from the authentication button, the lock pin retracts upward, and the slider assembly slides back due to the tension on the return spring. When the slider assembly reaches the end of its travel, the rocker arm is toggled down to an engaged position with the lead screw by a push-down ramp. The reengagement of the half-nut to the lead screw allows the Knife is ready to be re-activated. In some embodiments, to re-activate the Knife, the Knife User again places their hand on the authentication button and repeats the process. In various embodiments, any digit or portion of the hand can be used on the authentication button if an associated print is registered for the Knife.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a second Figure without disclaiming the inclusion of those elements in the embodiments illustrated or discussed in relation to the second Figure.

FIG. 1 illustrates a side view of a safety knife with a blade in an extended position from a handle, according to embodiments of the present disclosure.

FIGS. 2A and 2B illustrate views of a safety knife with a blade in an extended position showing inner mechanisms of the safety knife, according to embodiments of the present disclosure.

FIGS. 3A and 3B illustrate views of a safety knife with a blade in a retracted position showing inner mechanisms of the safety knife, according to embodiments of the present disclosure.

FIGS. 4A-4G illustrates several views of a slider assembly, according to embodiments of the present disclosure.

FIG. 5 illustrates railings included in a cover for a safety knife, according to embodiments of the present disclosure.

FIG. 6 is a flowchart of a method of operation of a safety knife, according to embodiments of the present disclosure.

### DETAILED DESCRIPTION

The present disclosure is generally related to a safety knife and a method of operation thereof. Although the safety knife shown in the Figures may be held and used in various orientations, a common XYZ axis is shown in each of the Figures to provide better understanding of the locational terms used in describing relative locations of elements shown in the illustrated examples. Accordingly, the terms upward, downward, forward, frontward, backward, rearward, leftward, rightward, and similar terminology shall be understood to refer to directions as defined in the present disclosure, regardless of the orientation that a user holds the safety knife. The terms leftward and left shall refer to the positive direction on the illustrated X axis, while the terms rightward and right shall refer to the negative direction on the illustrated X axis. The terms forward and frontward shall refer to the positive direction on the illustrated Y axis, while the terms backward and rearward shall refer to the negative direction on the illustrated Y axis. The terms upward, upper, above, up, and similar terms shall refer to the positive direction on the illustrated Z axis, while the terms downward, lower, below, down, and similar terms shall refer to the negative direction on the illustrated Z axis.

Additionally, although various features of the safety knife may be described as being on the left side or the right side relative to other features in reference to the examples provided in the Figures, the present disclosure contemplates a design mirrored on the ZY plane from the examples provided in the Figures.

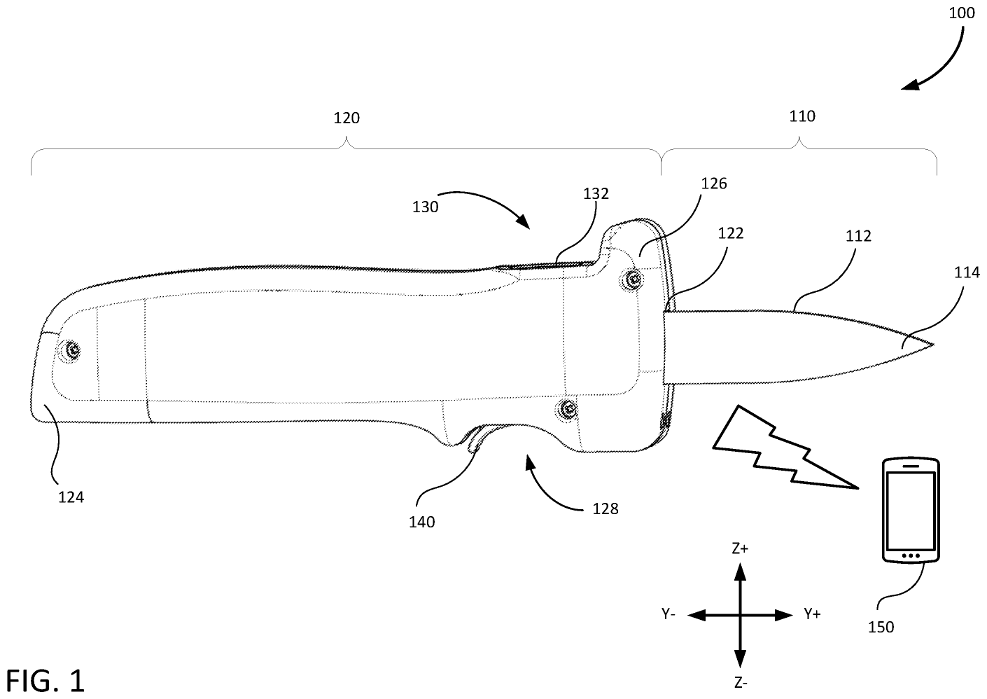

FIG. 1 illustrates a side view of a safety knife 100 with a blade 110 in an extended position from a handle 120, according to embodiments of the present disclosure.

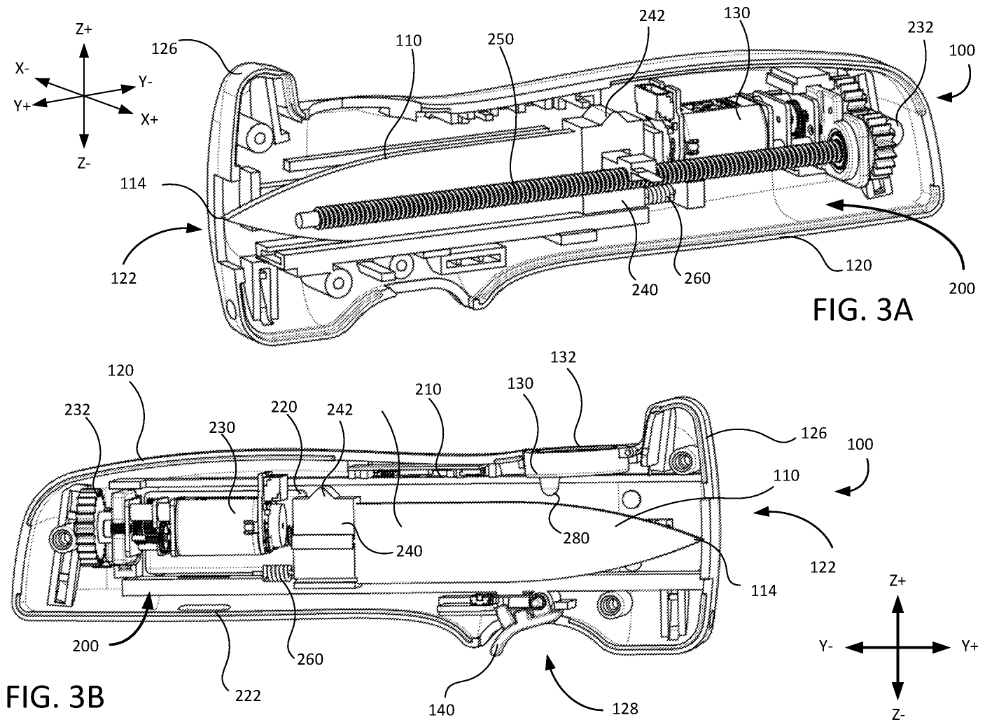

The blade 110 of the safety knife 100 protrudes from the handle 120 when in the extended positon (illustrated) and retracts into the handle 120 via an opening 122 defined in a guard 126 of the handle 120 when in the retracted position (see FIGS. 3A and 3B). In the retracted position, the cutting surfaces (e.g., the edge 112 and tip 114) of the blade 110 are held within the handle 120 to prevent the safety knife 100 from being used as a cutting or stabbing tool (either accidentally or by an unauthorized party). Although illustrated in FIG. 1 with a smooth double-edged blade 110, other designs for the cutting surfaces of blade 110 are contemplated that include single-edged blades 110, serrated blades 110, partially serrated and partially smooth-edged blades 110, edges 112 that run for a portion of the length of the blade (e.g., a swedge), and combinations thereof. Similarly, although illustrated in FIG. 1 with a spear point shape for the blade 110, other shapes for the blade 110 are contemplated that include clip point blades 110, tanto point blades 110, trailing point blades 110, straight back blades 110, wharncliffe blades 110, drop point blades 110, sheepsfoot blades 110, needle point blades 110, curved blades 110, etc.

The handle 120 of the safety knife 100 defines a cavity into which the blade 110 may be retracted when not in the extended position. The handle 120 is generally contoured to be held in one hand of a human user, and may be configured for a right-handed, left-handed, or ambidextrous grip with one or more finger grooves (not illustrated). The handle 120 includes a butt 124 (or pommel) and a guard 126 on opposite ends from one another. The guard 126 includes the opening 122 from which the blade 110 protrudes when in the extended position, provides a measure of protection for the fingers of the human user from the blade 110, and helps prevent the user's fingers from sliding forward when holding the handle 120. In various embodiments, the handle 120 may include or define one or more finger grooves 128 to help hold the user's fingers in a given location (e.g., to prevent forward or backward sliding), improve ergonomics of the safety knife 100, and encourage the user to use an intended gripping style. The butt 124 may also include various though-holes for the insertion of lanyard, keyrings, or the like, and may include a quillion or rearguard to help hold the user's fingers in place and not slip backwards from the handle 120.

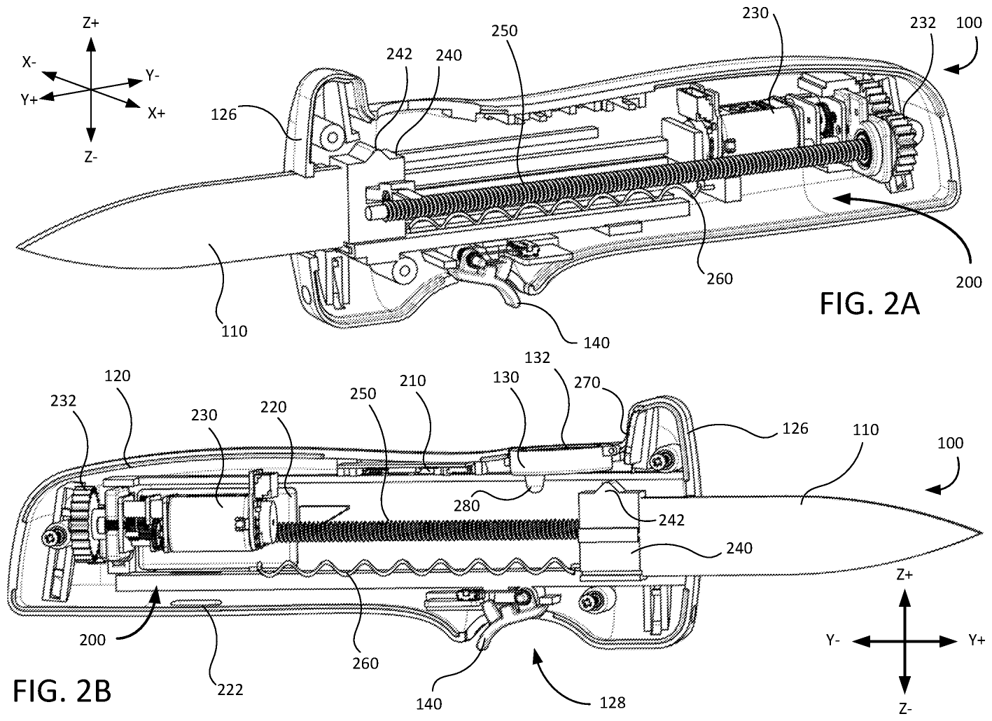

In various embodiments, the handle 120 is made of two components joined together with fasteners (e.g., screws, rivets, adhesives). These components may be substantially equal is size and shape, or may be unequally sized or shaped in various embodiments (e.g., in asymmetrical designs). In various symmetrical and asymmetrical designs, the handle 120 may centrally locate the opening 122 (e.g., evenly located rightward and leftward from a central line of the safety knife 100) to balance the safety knife 100 when configured for ambidextrous use. In some asymmetrical embodiments, the handle 120 may locate the opening 122 off-center (e.g., located rightward or leftward from a central line of the safety knife 100) to accommodate various internal elements of the safety knife 100 or aid in left-handed or right-handed use of the safety knife 100. Additionally, the handle 120 may include a port to allow for a charging cable (not illustrated) to charge a power storage unit (see FIGS. 2A-2B) used to extend the blade 110 and perform other tasks for operating the safety knife 100.

An authentication button 130 is located on an upper side of the handle 120 and rearward from the guard 126 and includes a print scanner 132 that is provided to read a biometric marker from a user of the safety knife 100. In various use patterns, the user applies the pad of the thumb or another finger (e.g., the distal phalanx) from which a fingerprint can be read as a biomarker to the print scanner 132 when actuating the authentication button 130. In other use patterns, the swirls and lines from the palmar surface of the hand or more medial portions of the fingers can be read as a biomarker in addition to or instead of fingerprints. A user may register one or more biomarkers of one or more types (e.g., a left thumbprint, a right thumbprint, a pattern from a portion of the left palm) to allow multiple patterns of use or grips of the safety knife (e.g., hammer grip, saber grip, reverse hammer, palm reinforced grip, etc.) with different placements of the hand on the handle 120. Additionally or alternatively, more than one user may register biomarkers with the safety knife 100.

In various embodiments, the authentication button 130 may be pushed downward, rearward, or forward, and combinations thereof to generally push the authentication button 130 inward to the handle 120. In various embodiments, the print scanner 132 is inactive (e.g., unpowered) until the user pushes actuates the authentication button 130 (e.g., to conserve power) or may be continuously active (e.g., powered) to improve a speed of collecting a biometric maker from a portion of the user's hand applied to the print scanner 132.

An activation trigger 140 is located on a lower side of the handle 120 (e.g., on the opposite side from the authentication button 130) and rearward from the guard 126. The activation trigger 140, when actuated, generates an activation signal that causes the safety knife 100 to extend the blade 110 when an authorized biometric marker is observed on the print scanner 132.

In various embodiments, the activation trigger 140 may be pushed upward, rearward, or forward, and combinations thereof (by an opposing portion of the user's hand to what is used to push the authentication button 130) to generally push the activation trigger 140 inward to the handle 120. For example, in a use pattern where the user actuates the authentication button 130 with a thumb, the activation trigger 140 may activated with one of the opposing fingers or palm of the same hand. In another example, in a use pattern where the user actuates the authentication button 130 with a non-thumb finger, the activation trigger 140 may activated with the thumb, palm, or heel of the same hand.

In various embodiments, the safety knife 100 may be paired with an external device 150, such as a cellphone or smartwatch, and may offload various computational tasks to the external device 150. For example, the safety knife 100 may transmit an alert request to the external device 150, which may connect to a cellular network to place an emergency phone call on behalf of the user of the safety knife 100 when the blade 110 is exposed.

FIGS. 2A and 2B illustrate a safety knife 100 with a blade 110 in an extended position showing inner mechanisms of the safety knife 100, according to embodiments of the present disclosure. FIG. 2A illustrates a view in which the left side of the handle 120 has been removed, while FIG. 2B illustrates a view in which the right side of the handle 120 has been removed. In each of the views, a portion of a cavity 200 is shown into which the blade 110 may be retracted (see FIGS. 3A and 3B) when not in use and in which various elements are included to extend and retract the blade 110. The elements include, a controller circuit 210, a power source 220, a motor assembly 230, a slider assembly 240, a lead screw 250, and a return spring 260. As shown in FIG. 2B, a port 222 is defined through the handle 120 (e.g., to allow access to charge the power source 220), a transceiver 270 (e.g., Bluetooth or a Radio Frequency Identifier (RFID) transmitter/receiver) is included in the guard 126 to wirelessly communicate with external devices (e.g., a paired smart phone), and lock pin 280 is included (as an anti-retraction feature) extending downward from the authentication button 130. Although the elements are shown in a given configuration, other configurations are contemplated based on the relative sizes of the elements.

FIGS. 3A and 3B illustrate a safety knife 100 with a blade 110 in a retracted position showing inner mechanisms of the safety knife 100, according to embodiments of the present disclosure. The view in FIG. 3A in the retracted position corresponds to the view in FIG. 2A in the extended position, and the view in FIG. 3B in the retracted position corresponds to the view in FIG. 2B in the extended position. Accordingly, the safety knife 100 in FIGS. 3A and 3B include the same elements as in the corresponding FIGS. 2A and 2G, although the blade 110 and the slider assembly 240 may obscure some of the elements in FIGS. 3A and 3B. Of note between the corresponding views, some or all of the blade 110 in FIGS. 2A and 2B is forward of the opening 122 in the handle 120, while all of the blade 110 in FIGS. 3A and 2B is rearward of the opening 122 in the handle 120 (e.g., contained in the cavity 200). Additionally, the return spring 260 is under greater tension in FIGS. 2A and 2B and under less (or no) tension in FIGS. 3A and 3B.

The authentication button 130 and the activation trigger 140 are connected to the controller circuit 210 to provide signals that the controller circuit 210 (or a paired device) can examine to determine whether to extend the blade 110. In various embodiments, the controller circuit 210 includes a microprocessor and memory to store various operating instructions for the safety knife 100, the biomarkers of a registered user, and contact information for using the transceiver 270 to connect with paired external devices (e.g., via a Bluetooth pairing).

A motor assembly 230 is included in the cavity 200 of the handle 120 to drive a slider assembly 240 that holds the blade 110 from the retracted position (e.g., FIGS. 3A and 3B) to the extended position shown (e.g., FIGS. 2A and 2B). The motor assembly 230 is powered by the power source 220 (e.g., a battery or capacitor) to turn a lead screw 250 that the slider assembly 240 selectively engages with to thereby push the slider assembly 240 forward. A return spring 260 is connected to the slider assembly 240 and an anchor point rearward of the slider assembly 240 to pull the slider assembly 240 (and the blade 110) back from the extended state to the retracted state. In various embodiments, the motor assembly 230 includes an electric motor that is controlled by the control circuit 210 to start and stop driving the lead screw 250, and may include various gearing arrangements 232 to adjust the torque and speed at which the lead screw 250 is driven.

The slider assembly 240 may be guided via rails defined in the handle 120 along an extension/retraction path (e.g., substantially in the Y direction) to transition between the extended state and the retracted state. The slider assembly 240 includes a half-nut that selectively interfaces with the lead screw 250 to translate the rotational motion or the lead screw 250 (imparted by the motor assembly 230) to a forward motion that moves the slider assembly 240 from the retracted state to the extended state. When the slider assembly 240 reaches the extended state, the half-nut is disengaged from the lead screw 250, thereby allowing the return spring 260 to pull the slider assembly 240 back to the retracted state. When the slider assembly 240 reaches the retracted state, the half-nut is reengaged with the lead screw 250, thereby allowing the lead screw to push the slider assembly 240 back to the extended state.

To resist returning the slider assembly 240 from the extended state to the retracted state, the authentication button 130 includes a lock pin 280. The lock pin 280 engages with the lock groove 242 on the slider assembly 240 to prevent retraction while a user is actuating the authentication button 130. During extension, a leading edge bevel on the lock groove 242 pushes the lock pin 280 (and the authentication button 130) upward, but the speed and force at which the slider assembly 240 extends, coupled with the inward forces exerted by the user on the authentication button 130 and activation trigger 140 allows the lock pin 280 to slide over the lock groove 242 and lock the blade 110 in the extended position until the user releases the authentication button 130.

Once extended, the lock pin 280 engages with the lock groove 242 to prevent backward motion of the slider assembly 240 until the user (at least partially) releases the authentication button 130 to thereby raise the lock pin 280 relative to the lock groove 242. Unlike the lead screw 250, which exerts sufficient force to push the lock pin 280 up and over the lock groove 242 when extending the blade 110, the return spring 260 exerts insufficient force to push the lock pin 280 out of the way to return the slider assembly 240 to the retracted state.

Although illustrated with a rearward edge bevel on the lock groove 242, which allows smooth action when retracting the blade 110 on release of the authentication button 130, in various examples, the lock groove 242 may omit the rearward edge bevel and instead include a rearward edge that is substantially perpendicular to the path of extension for the blade 110 to thereby reduce the likelihood of inadvertent retraction and decrease the force needed by the user to resist the return spring 260 pushing the lock pin 280 up and over the lock groove 242. Similarly, although illustrated with a forward edge bevel on the lock pin 280, which allows smooth action when retracting the blade 110 on release of the authentication button 130, in various examples, the lock pin 280 may omit the forward edge bevel and instead include a forward edge that is substantially perpendicular to the path of extension for the blade 110 to thereby reduce the likelihood of inadvertent retraction and decrease the force needed by the user to resist the return spring 260 pushing the lock pin 280 up and over the lock groove 242.

Once retracted, the lock pin 280 engages with the lock groove 242 to prevent backward motion of the slider assembly 240 until the user (at least partially) releases the authentication button 130 to thereby raise the lock pin 280 relative to the lock groove 242. Unlike the lead screw 250, which exerts sufficient force to push the lock pin 280 up and over the lock groove 242 when extending the blade 110, the return spring 260 exerts insufficient force to push the lock pin 280 out of the way to return the slider assembly 240 to the retracted state.

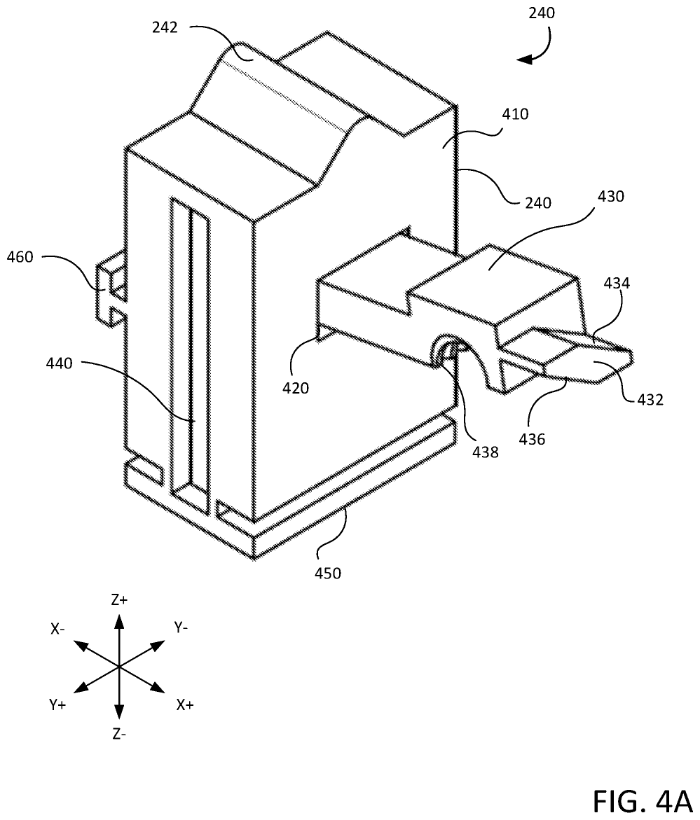

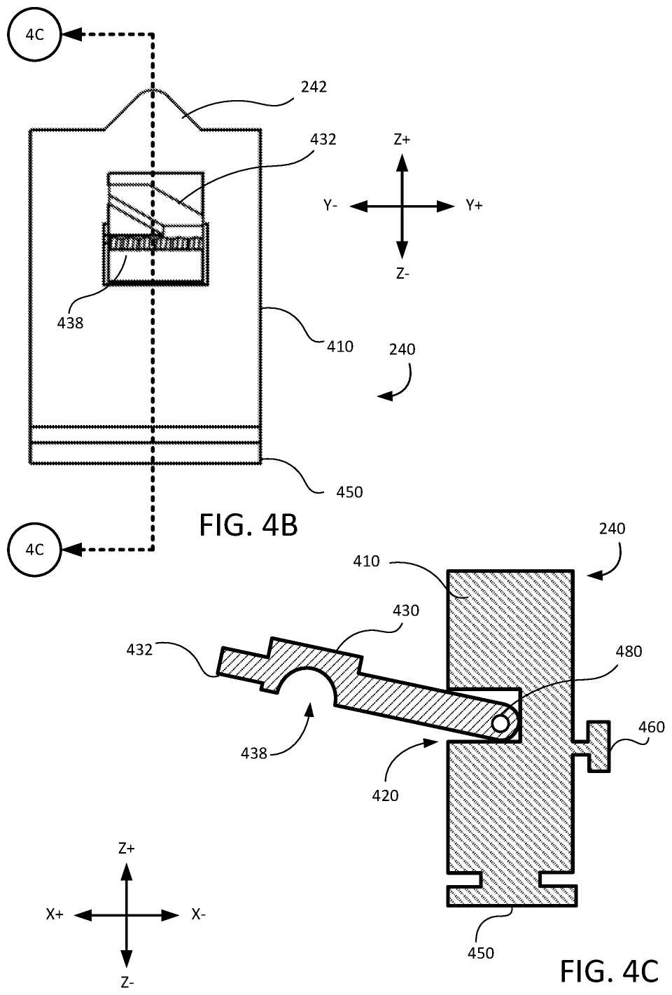

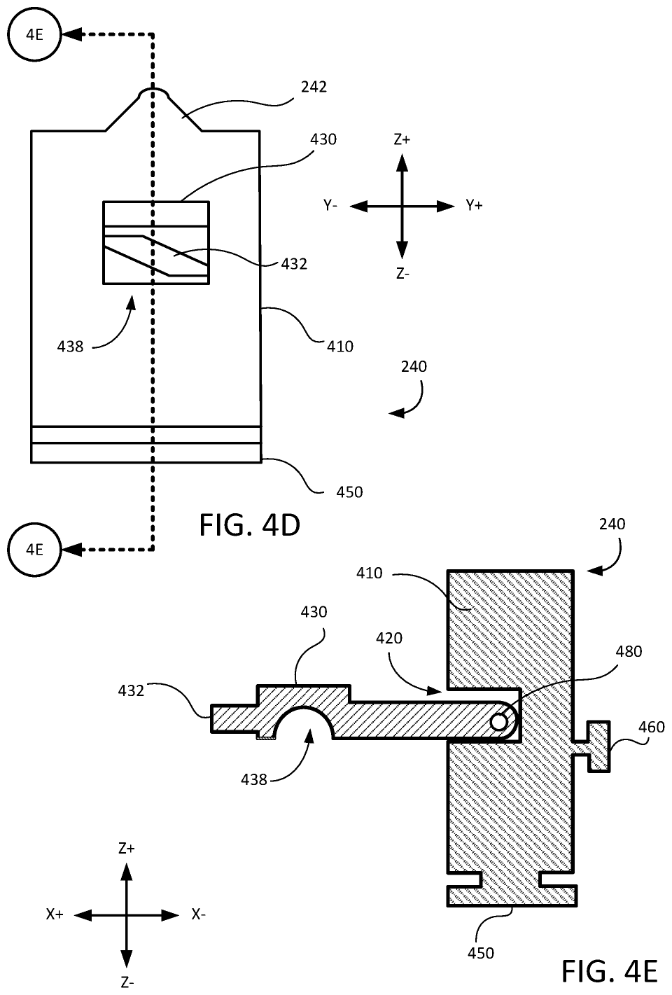

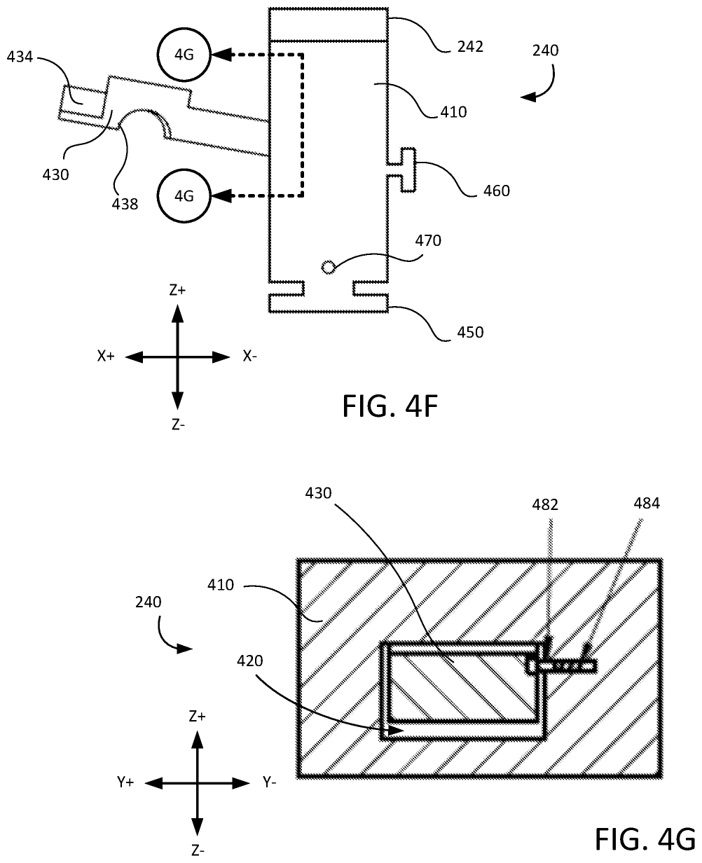

FIGS. 4A-4G illustrates several views of a slider assembly 240, according to embodiments of the present disclosure.

FIG. 4A is an isometric view of the slider assembly 240 and the features thereof. The body 410 of the slider assembly 240 defines the lock groove 242 on an upper side, an arm hole 420 of a first side (positive X/left side in the illustrated example), a blade hole 440 on the forward side, a bottom runner 450 on the bottom side, a side runner 460 on a second side opposite to the first side (negative X/right side in the illustrated example). Although not shown in FIG. 4A, a spring attachment point 470 is also defined in the body 410 of the slider assembly 240 (see FIG. 4E) to allow the return spring 260 to attach to the slider assembly 240.

The bottom runner 450 and the side runner 460 include cutouts from the body 410 of the slider assembly 240 that are matched to rails defined in the handle 120 of the safety knife 100. The bottom runner 450 and the side runner 460 fit into these rails, allowing the slider assembly 240 to stay substantially immobile in the X direction and the Z direction as the slider assembly 240 translates in the Y direction.

The blade hole 440 allows insertion a portion of the blade 110 (e.g., the tang) into the body 410 of the slider assembly 240, which may be secured therein by screws, rivets, adhesives, pressure, or the like. Similarly, the arm hole 420 allows insertion of a portion of a rocker arm 430 into the body 410 of the slider assembly 240.

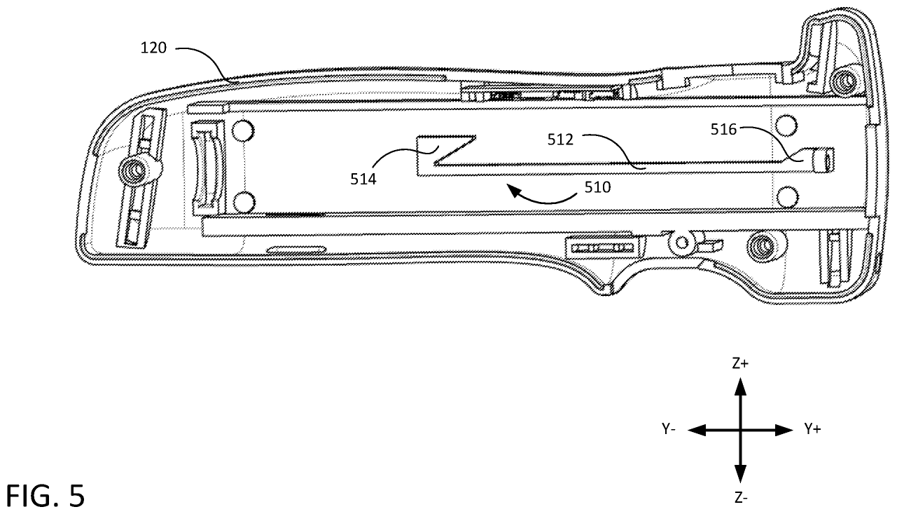

The rocker arm 430 includes a guide rib 432 (located on a distal side of the rocker arm 430 from the body 410) with a push-up edge 436 on a lower-forward side and a push-down edge 434 on an upper-rear side. As described in greater detail in regard to FIG. 5, these edges interact with an engagement rail defined on one inner surface of the handle 120 to push a half-nut 438 included in the rocker arm into or out of contact with the lead screw 250. The half-nut 438 includes threads matched to the treads on the lead screw 250 so that, as the lead screw 250 rotates, the half-nut 438 is pushed along the length of the lead screw when the threads are engaged.

FIG. 4B is a side view of the slider assembly 240 showing the rocker arm 430, and FIG. 4C is a cutaway view of the slider assembly 240 (as indicated in FIG. 4B) providing additional details of the rocker arm 430. A portion of the rocker arm 430 is inserted into the arm hole 420, and is mated to the slider assembly 240 via a hinge 480 or axel that allows the rocker arm 430 to rotate about a Y axis. The dimensions of the arm hole 420 relative to the dimensions of the rocker arm 430 may contain the amount of rotation that the rocker arm 430 is capable of. FIGS. 4B and 4C illustrate the rocker arm 430 in a disengaged rotational state, where the rocker arm 430 would position the half-nut 438 off of the lead screw 260 (if included in FIGS. 4B and 4C).

FIG. 4D is a side view of the slider assembly 240 showing the rocker arm 430, and FIG. 4E is a cutaway view of the slider assembly 240 (as indicated in FIG. 4D) providing additional details of the rocker arm 430. A portion of the rocker arm 430 is inserted into the arm hole 420, and is mated to the slider assembly 240 via a hinge 480 or axel that allows the rocker arm 430 to rotate about a Y axis. The dimensions of the arm hole 420 relative to the dimensions of the rocker arm 430 may contain the amount of rotation that the rocker arm 430 is capable of. FIGS. 4D-4E illustrate the rocker arm 430 in an engaged rotational state, where the rocker arm 430 would position the half-nut 438 onto the lead screw 260 (if included in FIGS. 4D and 4E).

FIG. 4F is a rear view of the slider assembly 240, in which the spring attachment point 470 is visible. The spring attachment point 470 is located centrally on the X axis to reduce friction induced between the bottom runner 450 and a corresponding rail by the return spring 260 when placed under tension.

FIG. 4G is a detailed view of a state locking mechanism in the arm hole 420, taken in cross-section as indicated in FIG. 4F. FIG. 3G may be understood in conjunction with FIG. 5. A ball 482 is pushed outward by a state spring 484 to maintain the rocker arm 430 in one of the engaged or disengaged states until pushed into the other state via the guide rib 432. Although illustrated on the rearward side of the arm hole 420, in various embodiments the ball 482 and state spring 484 may be positioned on the front side in the arm hole 420. When the rocker arm 430 is in the engaged state, the state spring 484 pushes the ball 482 outward, to extend (partially) into the arm hole 420, which impede the ability of the rocker arm 430 to disengage by bouncing off of the lead screw 260 to the safety knife 100 being held upside down. However, the force imparted by the push-up edge 436 interacting with the push-up ramp 516 when the blade 110 is being extended is sufficient to push the ball 482 inward toward the state spring 484, and allow the rocker arm 430 to rotate to the disengaged state. The force exerted by the state spring 484 pushes the ball 482 into the rocker arm 430 when in the engaged state to resist returning to the engaged state until the push-down ramp 514 interacts with the push-down edge 434 to return the rocker arm 430 to the engaged state.

FIG. 5 illustrates railings included in a cover for a safety knife, according to embodiments of the present disclosure. The rail 510 on the inner side of the handle 120 corresponding to direction that the rocker arm 430 extends from the slider assembly 240 includes a run portion 512 that terminates on one end (where the rocker arm 430 rests when the slider assembly 240 is in the retracted state) in a push-down ramp 514 and on the other end (where the rocker arm 430 rests when the slider assembly 240 is in the extended state) with a push-up ramp 516. In various embodiments, the run portion 512 may be omitted, and the push-down ramp 514 and the push-up ramp 516 extend from the inner side of the handle 120 at appropriate locations.

As described in relation to FIG. 4G, the state spring 484 and ball 482 lock the rocker arm 430 in place in one of two states (e.g., either engaged with or disengaged from the lead screw 250), until acted on. The forward or backward motion of the slider assembly 240 moves the guide rib 432 into contact with the push-down ramp 514 (when entering the retracted state) or the push-up ramp 516 (when entering the extended state). The push-up ramp 516 engages with the push-up edge 436 of the rocker arm 430 to disengage the half-nut 438 from the lead screw 260 when the blade 110 is extending; transitioning from the engaged state to the disengaged state. The push-up ramp 516 and the push-up edge 436 interact with one another to use the forward motion of the slider assembly 240 to lift the half-nut 438 off of the lead screw 250. The half-nut 438 remains disengaged from the lead screw 260 until the slider assembly 240 is retracted sufficiently to engage the push-down edge 434 of the rocker arm 430 with the push-down ramp 514, which uses the rearward motion of the slider assembly 240 to push the half-nut 438 onto of the lead screw 260.

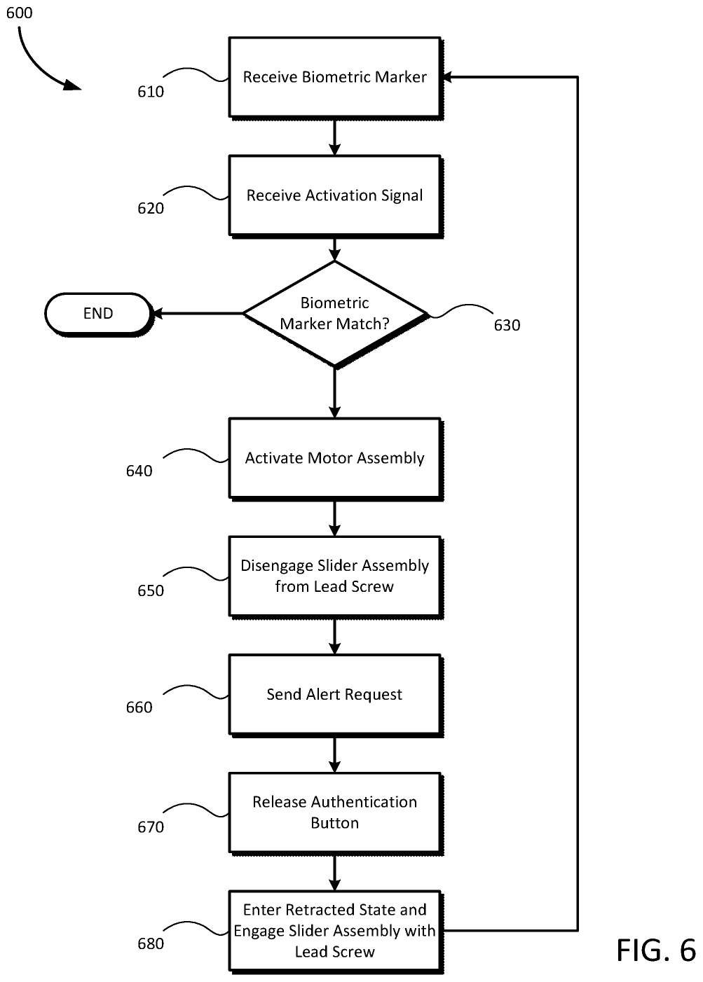

FIG. 6 is a flowchart of a method of operation of a safety knife, according to embodiments of the present disclosure. When starting from the retracted state, method 600 begins a block 610, block 620, or substantially simultaneously at block 610 and block 620. When starting from the extended state, method 600 begins at block 670.

At block 610, a print scanner included in an authentication button of a safety knife receives a biometric mater (e.g., a finger print from a thumb or other finger of a user attempting to use the safety knife, a pattern of swirls and lines from the palm). In various embodiments, the print scanner scans a body part placed on the print scanner in response to the authentication button being actuated (e.g., held down by a user).

At block 620, the safety knife receives an activation signal from an activation trigger included in the safety knife. In various embodiments block 620 may be performed before block 610,

At block 630, the safety knife determines whether the biometric marker received per block 610 matches an authorized maker. In various embodiments, a controller chip locally determines whether the supplied biometric marker matches one stored for an authorized user, or may transmit the data via a transceiver to a paired device (e.g., a smartphone) to compare the supplied biometric maker against one or more stored biometric markers. When a match is determined, method 600 proceeds to block 640. Otherwise, method 600 may conclude.

At block 640, the controller chip activates a motor assembly to turn a lead screw included in the safety knife. In various embodiments, the lead screw may turn for a predetermined amount of time or number or rotations in response to being activated, or may continue turning as long as the activation trigger remains actuated. The rotation of the lead screw imparts a forward translational movement to a slider assembly holding a blade, which extends to the extended position. Extending the slider assembly, applies tension to a return spring, which seeks to pull the slider assembly (and the blade) back to the retracted position. The slider assembly resists the backwards force applied by the return spring via a lock-groove interfacing with a lock pin or other anti-retraction feature included on the authentication button, which is held in place by the user holding down on the authentication button.

At block 650, the slider assembly disengages from the lead screw. For example, a half-nut mounted on a rocker arm included in the slider assembly may be guided off of the lead screw when the slider assembly reaches the extended state via a push-up block interacting with a push-up ramp. The interaction of the push-up block on the rocker arm with the push-up ramp uses the forward motion of the slider assembly to also lift one end of the rocker arm, thereby disengaging the half-nut from the lead screw.

In various embodiments, the safety knife sends an alert request to a paired device at block 660. For example, a cell phone paired with the safety device may receive the alert request and generate a phone call to a police department, emergency services number, trusted contact or the like. In various embodiments, the alert request may also activate a camera, microphone, flashlight, global positioning system (GPS) transceiver, or audio recorder on the paired device to allow the user of the safety knife to use the paired device without letting go of the safety knife. In various embodiments, the alert request can instruct the paired device to output an automated message (e.g., a recorded or computer generated phone call for help at the user's location) included in a phone call or message to a third party, or may produce output to draw the attention of passersby that the user has drawn the safety knife and may be in need of assistance.

At block 670, when the blade is in the extended state, the user releases the authentication button, thereby raising the lock pin above the lock groove of the slider assembly, and allowing the return spring to pull the slider block back into the cavity of the handle.

At block 680, the slider assembly (re)enters the retracted state and the slider assembly (re)engages with the lead screw. For example, a half-nut mounted on a rocker arm included in the slider assembly may be guided onto the lead screw when the slider assembly reaches the retracted state via a push-down block interacting with a push-down ramp. The interaction of the push-down block on the rocker arm with the push-down ramp uses the backward motion of the slider assembly to also lower one end of the rocker arm, thereby engaging the half-nut with the lead screw. Method 600 may then return to block 610 (or block 620) to extend the blade to the extended position.

The present disclosure may also be understood by the following clauses, such that:

Clause 1: A safety knife, comprising: a handle, defining a cavity with an opening on a first end of the handle, and including a print scanner on a first exterior side and an activation trigger on a second exterior side, opposite to the first exterior side; a slider assembly, at least partially disposed in the cavity, including a half-nut and a blade; a motor disposed in the cavity configured to rotate a lead screw engaged with the half-nut when the print scanner matches a received biometric marker to a stored biometric marker and when the activation trigger is engaged, wherein rotation of the lead screw when engaged with the half-nut pushes the slider assembly in a first direction to expose the blade from the cavity via the opening; and a return spring disposed within the cavity connected to the slider assembly and to a second end of the handle opposite to the first end, wherein pushing the slider assembly in the first direction places the return spring under tension and the return spring pulls the slider assembly in a second direction, opposite to the first direction, to retract the blade into the cavity after being exposed when the half-nut disengages the lead screw.

Clause 2: A safety knife as described in any combination of clauses 1 and 3-7, further including a transceiver that transmits an alert request to a paired device in response to the blade being exposed from the cavity.

Clause 3: A safety knife as described in any combination of clauses 1, 2, and 4-7, wherein: the slider assembly includes a lock groove extending towards the first exterior side; the print scanner is included on an authentication button including a lock pin extending into the cavity; and the lock pin engages with lock groove to keep the blade exposed while the authentication button remains actuated.

Clause 4: A safety knife as described in any combination of clauses 1-3 and 5-7, wherein the motor is connected to the lead screw via a gearing arrangement.

Clause 5: A safety knife as described in any combination of clauses 1-4, 6, and 7, further comprising a guard, located between both the print scanner and the activation trigger and the blade when the blade is exposed.

Clause 6: A safety knife as described in any combination of clauses 1-5 and 7, wherein the slider assembly includes a rocker arm on which the half-nut is mounted, the rocker arm including: a guide rib including a push-up edge on a first side and a push-down edge on a second side, the push-up edge configured to interact with a push-up ramp defined in the handle to disengage the half-nut from the lead screw using movement of the slider assembly in the first direction and the push-down edge configured to interact with a push-down ramp defined in the handle to engaged the half-nut with the lead screw using movement of the slider assembly in the second direction.

Clause 7: A safety knife as described in any combination of clauses 1-6, wherein the rocker arm is mounted in an arm hole defined in the slider assembly, the arm hole including: a ball; and a state spring configured to push the ball into the rocker arm to maintain the rocker arm in one of an engaged state with the lead screw or a disengaged state with the lead screw until the guide rib interacts with one or the push-up ramp or push-down ramp.

Clause 8: A method, comprising: in response to determining that a biometric marker received from a print scanner matches an authorized biometric marker and receiving an activation signal from an activation trigger, activating a motor assembly to rotate a lead screw; pushing, via rotation of the lead screw, a slider assembly held in contact with the lead screw via a half-nut in a first direction to expose a blade from a handle; disengaging the half-nut from the lead screw when the slider assembly reaches an extended state; in response to a release of an authentication button, pulling, via a return spring connected to the slider assembly and placed under tension when pushing the slider assembly in the first direction, the slider assembly in a second direction, opposite to the first direction to retract the blade into the handle; and engaging the half-nut onto the lead screw when the slider assembly reaches an retracted state.

Clause 9: A method as described in any combination of clauses 8, 10, and 11, wherein: the authentication button includes a lock pin extending in a first direction from the authentication button towards the lead screw; the slider assembly includes a lock groove extending in a second direction, opposite to the first direction; and pushing, via rotation of the lead screw, the slider assembly in the first direction engages with lock groove with the lock pin to keep the blade exposed while the authentication button remains actuated.

Clause 10: A method as described in any combination of clauses 8, 9, and 11, further comprising: transmitting an alert request to a paired device in response to exposing the blade.

Clause 11: A method as described in any combination of clauses 8-10, wherein the motor assembly is activated for a predetermined amount of time to rotate the lead screw in response to determining that the biometric marker received from the print scanner matches the authorized biometric marker and receiving the activation signal from the activation trigger.

Clause 12: A safety knife, comprising: a slider assembly; connected on a first side to a blade and on a second side, opposite to the first side, to a return spring; a handle having an opening on a first end and to which the return spring is connected on a second end; a motor assembly connected to a lead screw running from the first end of the handle to the second end of the handle; and a rocker arm connected to the slider assembly via a hinge and selectively engaged to the lead screw via a half-nut; and wherein the slider assembly is configured to move the blade to an extended state through the opening to outside of the handle from a retracted state within the handle via rotation the lead screw and return the blade from the extended state to the retracted state via the return spring.

Clause 13: A safety knife as described in any combination of clauses 12 and 14-20, wherein the motor assembly is connected to the lead screw via a gearing arrangement.

Clause 14: A safety knife as described in any combination of clauses 12, 13, and 15-20, further comprising a transceiver paired with an external device to generate an alert request to the external device when the blade is in the extended state.

Clause 15: A safety knife as described in any combination of clauses 12-14 and 16-20, further comprising: an authentication button, located on a first side of the handle, proximate to the first end; and an activation trigger, located on a second side of the handle, opposite to the first side, proximate to the first end; and wherein simultaneously actuating the authentication button and the activation trigger generates and activation signal for the motor assembly to rotate the lead screw.

Clause 16: A safety knife as described in any combination of clauses 12-15 and 17-20, wherein: the authentication button includes a print scanner that captures a biometric marker when the authentication button is actuated; and the activation signal is not generated unless the biometric marker captured by the print scanner matches an authorized biometric marker.

Clause 17: A safety knife as described in any combination of clauses 12-16 and 18-20, wherein the authentication button includes a lock pin configured to engage a lock groove included on the slider assembly when the blade is in the extended state that prevents the return spring from returning the blade from the extended state to the retracted state while engaged.

Clause 18: A safety knife as described in any combination of clauses 12-17, 19, and 20, wherein the rocker arm includes: a guide rib including a push-up edge on a first side and a push-down edge on a second side, the push-up edge configured to interact with a push-up ramp defined in the handle to disengage the half-nut from the lead screw using movement of the slider assembly in a first direction and the push-down edge configured to interact with a push-down ramp defined in the handle to engaged the half-nut with the lead screw using movement of the slider assembly in a second direction opposite to the first direction.

Clause 19: A safety knife as described in any combination of clauses 12-18 and 20, wherein the rocker arm is mounted in an arm hole defined in the slider assembly, the arm hole including: a ball; and a state spring configured to push the ball into the rocker arm to maintain the rocker arm in one of an engaged state with the lead screw or a disengaged state from the lead screw until the guide rib interacts with one or the push-up ramp or push-down ramp.

Clause 20: A safety knife as described in any combination of clauses 12-19, wherein the handle includes a guard located on the first end.

The preceding disclosures are illustrative embodiments. It should be appreciated by those of skill in the art that the devices, techniques and methods disclosed herein elucidate representative embodiments that function well in the practice of the present disclosure. However, those of skill in the art should, in light of the present disclosure, appreciate that many changes can be made in the specific embodiments that are disclosed and still obtain a like or similar result without departing from the spirit and scope of the invention.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects those of ordinary skill in the art to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A safety knife, comprising:
a handle, defining a cavity with an opening on a first end of the handle, and including a print scanner on a first exterior side and an activation trigger on a second exterior side, opposite to the first exterior side;
a slider assembly, at least partially disposed in the cavity, including a half-nut and a blade;
a motor disposed in the cavity configured to rotate a lead screw engaged with the half-nut when the print scanner matches a received biometric marker to a stored biometric marker and when the activation trigger is engaged, wherein rotation of the lead screw when engaged with the half-nut pushes the slider assembly in a first direction to expose the blade from the cavity via the opening; and
a return spring disposed within the cavity connected to the slider assembly and to a second end of the handle opposite to the first end, wherein pushing the slider assembly in the first direction places the return spring under tension and the return spring pulls the slider assembly in a second direction, opposite to the first direction, to retract the blade into the cavity after being exposed when the half-nut disengages the lead screw.

2. The safety knife of claim 1, further comprising a transceiver that transmits an alert request to a paired device in response to the blade being exposed from the cavity.

3. The safety knife of claim 1, wherein:
the slider assembly includes a lock groove extending towards the first exterior side;
the print scanner is included on an authentication button including a lock pin extending into the cavity; and
the lock pin engages with lock groove to keep the blade exposed while the authentication button remains actuated.

4. The safety knife of claim 1, wherein the motor is connected to the lead screw via a gearing arrangement.

5. The safety knife of claim 1, further comprising a guard, located between both the print scanner and the activation trigger and the blade when the blade is exposed.

6. The safety knife of claim 1, wherein the slider assembly includes a rocker arm on which the half-nut is mounted, the rocker arm including:
a guide rib including a push-up edge on a first side and a push-down edge on a second side, the push-up edge configured to interact with a push-up ramp defined in the handle to disengage the half-nut from the lead screw using movement of the slider assembly in the first direction and the push-down edge configured to interact with a push-down ramp defined in the handle to engaged the half-nut with the lead screw using movement of the slider assembly in the second direction.

7. The safety knife of claim 6, wherein the rocker arm is mounted in an arm hole defined in the slider assembly, the arm hole including:
a ball; and
a state spring configured to push the ball into the rocker arm to maintain the rocker arm in one of an engaged state with the lead screw or a disengaged state with the lead screw until the guide rib interacts with one or the push-up ramp or push-down ramp.

8. A method, comprising:
in response to determining that a biometric marker received from a print scanner matches an authorized biometric marker and receiving an activation signal from an activation trigger, activating a motor assembly to rotate a lead screw;
pushing, via rotation of the lead screw, a slider assembly held in contact with the lead screw via a half-nut in a first direction to expose a blade from a handle;
disengaging the half-nut from the lead screw when the slider assembly reaches an extended state;
in response to a release of an authentication button, pulling, via a return spring connected to the slider assembly and placed under tension when pushing the slider assembly in the first direction, the slider assembly in a second direction, opposite to the first direction to retract the blade into the handle; and
engaging the half-nut onto the lead screw when the slider assembly reaches an retracted state.

9. The method of claim 8, wherein:
the authentication button includes a lock pin extending in a first direction from the authentication button towards the lead screw;
the slider assembly includes a lock groove extending in a second direction, opposite to the first direction; and
pushing, via rotation of the lead screw, the slider assembly in the first direction engages with lock groove with the lock pin to keep the blade exposed while the authentication button remains actuated.

10. The method of claim 8, further comprising:
transmitting an alert request to a paired device in response to exposing the blade.

11. The method of claim 8, wherein the motor assembly is activated for a predetermined amount of time to rotate the lead screw in response to determining that the biometric marker received from the print scanner matches the authorized biometric marker and receiving the activation signal from the activation trigger.

12. A safety knife, comprising:
a slider assembly; connected on a first side to a blade and on a second side, opposite to the first side, to a return spring;
a handle having an opening on a first end and to which the return spring is connected on a second end;
a motor assembly connected to a lead screw running from the first end of the handle to the second end of the handle; and
a rocker arm connected to the slider assembly via a hinge and selectively engaged to the lead screw via a half-nut; and
wherein the slider assembly is configured to move the blade to an extended state through the opening to outside of the handle from a retracted state within the handle via rotation the lead screw and return the blade from the extended state to the retracted state via the return spring.

13. The safety knife of claim 12, wherein the motor assembly is connected to the lead screw via a gearing arrangement.

14. The safety knife of claim 12, further comprising a transceiver paired with an external device to generate an alert request to the external device when the blade is in the extended state.

15. The safety knife of claim 12, further comprising:
an authentication button, located on a first side of the handle, proximate to the first end; and
an activation trigger, located on a second side of the handle, opposite to the first side, proximate to the first end; and
wherein simultaneously actuating the authentication button and the activation trigger generates and activation signal for the motor assembly to rotate the lead screw.

16. The safety knife of claim 15, wherein:
the authentication button includes a print scanner that captures a biometric marker when the authentication button is actuated; and
the activation signal is not generated unless the biometric marker captured by the print scanner matches an authorized biometric marker.

17. The safety knife of claim 15, wherein the authentication button includes a lock pin configured to engage a lock groove included on the slider assembly when the blade is in the extended state that prevents the return spring from returning the blade from the extended state to the retracted state while engaged.

18. The safety knife of claim 12, wherein the rocker arm includes:
a guide rib including a push-up edge on a first side and a push-down edge on a second side, the push-up edge configured to interact with a push-up ramp defined in the handle to disengage the half-nut from the lead screw using movement of the slider assembly in a first direction and the push-down edge configured to interact with a push-down ramp defined in the handle to engaged the half-nut with the lead screw using movement of the slider assembly in a second direction opposite to the first direction.

19. The safety knife of claim 18, wherein the rocker arm is mounted in an arm hole defined in the slider assembly, the arm hole including:
a ball; and
a state spring configured to push the ball into the rocker arm to maintain the rocker arm in one of an engaged state with the lead screw or a disengaged state from the lead screw until the guide rib interacts with one or the push-up ramp or push-down ramp.

20. The safety knife of claim 12, wherein the handle includes a guard located on the first end.
